(19) United States
(12) Patent Application Publication
(10) Pub. No.: US 2016/0152419 A1
(43) Pub. Date: Jun. 2, 2016

(54) DELIVERY METHOD

(71) Applicants: INVENTEC (PUDONG) TECHNOLOGY CORPORATION, Shanghai City (CN); INVENTEC CORPORATION, Taipei City (TW)

(72) Inventors: CHIH-CHIEN LIN, Taipei City (TW); WEI-HSUAN CHANG, Taipei City (TW)

(21) Appl. No.: 14/677,747

(22) Filed: Apr. 2, 2015

(30) Foreign Application Priority Data
Nov. 27, 2014 (CN) 201410707238.8

(51) Int. Cl. B65G 47/90; B65G 47/91

(52) U.S. Cl. CPC B65G 47/90; B65G 47/91

(57) ABSTRACT

A delivery method for placing a plurality of objects at a plurality of predetermined positions of a loading component includes the following steps. A plurality of placement regions are defined, the plurality of objects are placed at the plurality of placement regions respectively, the quantity of the plurality of placement regions is equal to the quantity of the plurality of predetermined positions of the loading component, and the plurality of placement regions are corresponding to the plurality of predetermined positions one-by-one. Each object is picked up from each placement region, and placed at each predetermined position corresponding to each placement region.

### CROSS-REFERENCE TO RELATED APPLICATIONS

This non-provisional application claims priority under 35 U.S.C. §119(a) on Patent Application No(s). 201410707238.8 filed in China on Nov. 27, 2014, the entire contents of which are hereby incorporated by reference.

### BACKGROUND OF THE INVENTION

1. Technical Field of the Invention

The disclosure relates to a delivery method. More particularly, the disclosure relates to an automatic delivery method for increasing delivery efficiency.

2. Description of the Related Art

In recent years, with the development of technology, the calculation speed of an electronic device has been raised. However, with the increment of the calculation speed, the heat generated by the electronic device is also increased. Thus, the requirement for a heat-dissipating module has augmented for removing the heat generated by the electronic device.

For example, the heat-dissipating module is a heat dissipation fin set which is disposed on a heat source (such as a chip) of a substrate. The heat dissipation fin set conducts the heat generated by the heat source, and then dissipates the heat to the region neighboring to the electronic device by heat convection. Accordingly, the heat generated by the heat source can be removed from the electronic device.

Moreover, a plurality of heat dissipation fin sets can be disposed on several chips of a printed circuit board (PCB). In the assembly process of the PCB, the heat dissipation fin sets are disposed on a loading plate first. Then, the heat dissipation fin sets are picked up sequentially and placed at a jig by an electronic arm. Then, a pick-up mechanism is driven to pick up the heat dissipation fin sets at the same time, and to place the heat dissipation fin sets at the chip of the PCB correspondingly. That is, the assembly process of the PCB has been finished.

However, in the assembly process of the PCB as above-mentioned, the delivery path of the electronic arm is too long to save on assembly time and cost.

### SUMMARY OF THE INVENTION

One aspect of the disclosure provides a delivery method for placing a plurality of objects at a plurality of predetermined positions of a loading component, which comprises the following steps. A plurality of placement regions are defined, the plurality of objects are placed on the plurality of placement regions respectively, the quantity of the plurality of placement regions is equal to the quantity of the plurality of predetermined positions of the loading component, and the plurality of placement regions are corresponding to the plurality of predetermined positions one-by-one. Each object is picked up from each placement region, and placed at each predetermined position corresponding to each placement region.

Another aspect of the disclosure provides a delivery method for placing a plurality of heat dissipation fin sets at a first position, a second position, a third position and a fourth position of a loading component, which comprises the following steps. A first region, a second region, a third region and a fourth region are defined on a carrier, the plurality of heat dissipation fin sets are placed at the first region, the second region, the third region and the fourth region, the first region is corresponding to the first position, the second region is corresponding to the second position, the third region is corresponding to the third position, the fourth region is corresponding to the fourth position, a plurality of relative positions of the first region, the second region, the third region and the fourth region are corresponding to a plurality of relative positions of the first position, the second position, the third position and the fourth position, and the first position, the second position, the third position and the fourth position are arranged in a 2×2 matrix. Each heat dissipation fin set is picked up from the first region and placed at the first position of the loading component by the electronic arm. Each heat dissipation fin set is picked up from the second region and placed at the second position of the loading component by the electronic arm. Each heat dissipation fin set is picked up from the third region and placed at the third position of the loading component by the electronic arm. Each heat dissipation fin set is picked up from the fourth region and placed at the fourth position of the loading component by the electronic arm.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1A is a perspective view of an assembly system from a first viewpoint according to an embodiment of the disclosure;

FIG. 1B is a perspective view of the assembly system from a second viewpoint according to the embodiment of the disclosure;

FIG. 2 is a block diagram of a loading component and a carrier of the assembly system according to the embodiment of the disclosure;

FIG. 3 is a flow diagram of a delivery method according to the embodiment of the disclosure;

FIG. 4 is a flow diagram of a step S300 in the delivery method according to the embodiment of the disclosure;

FIG. 5 is a first schematic diagram of the delivery method applied to the assembly system according to the embodiment of the disclosure during operation;

FIG. 6 is a second schematic diagram of the delivery method applied to the assembly system according to the embodiment of the disclosure during operation;

FIG. 7 is a third schematic diagram of the delivery method applied to the assembly system according to the embodiment of the disclosure during operation;

FIG. 8 is a fourth schematic diagram of the delivery method applied to the assembly system according to the embodiment of the disclosure during operation; and

FIG. 9 is a block diagram of a loading component and a carrier of an assembly system according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The disclosure provides a delivery method applied to an assembly system. In this embodiment, the assembly system is used for automatically assembling a plurality of objects with a substrate. In other words, the assembly system is used for delivering the objects to a loading component according to the delivery method for follow-up assembly processes.

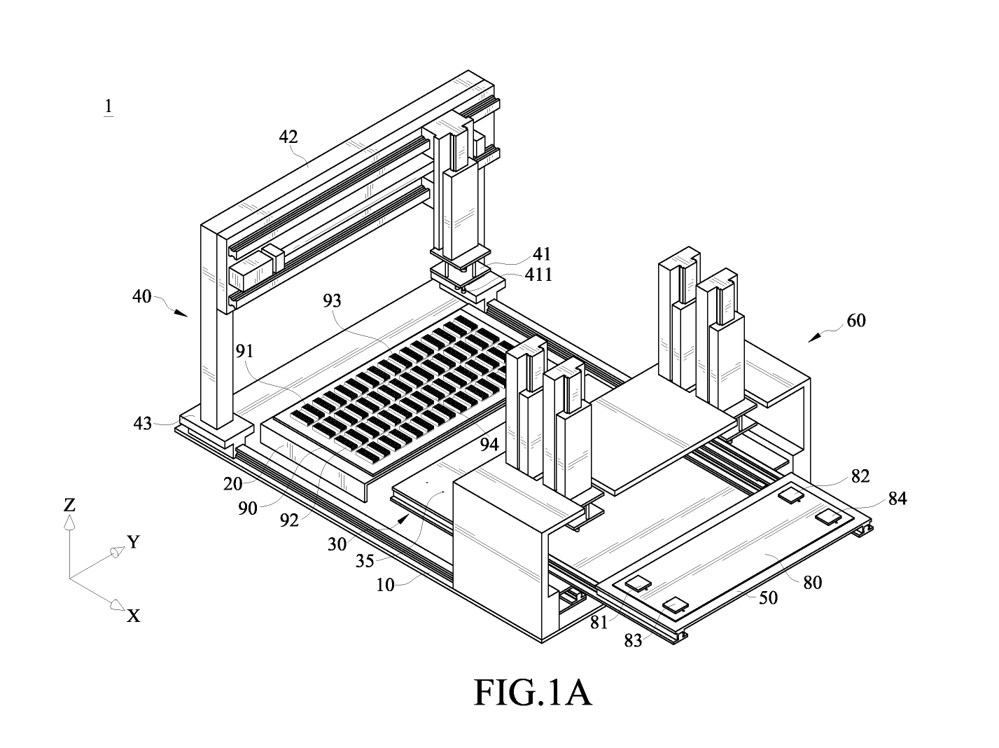

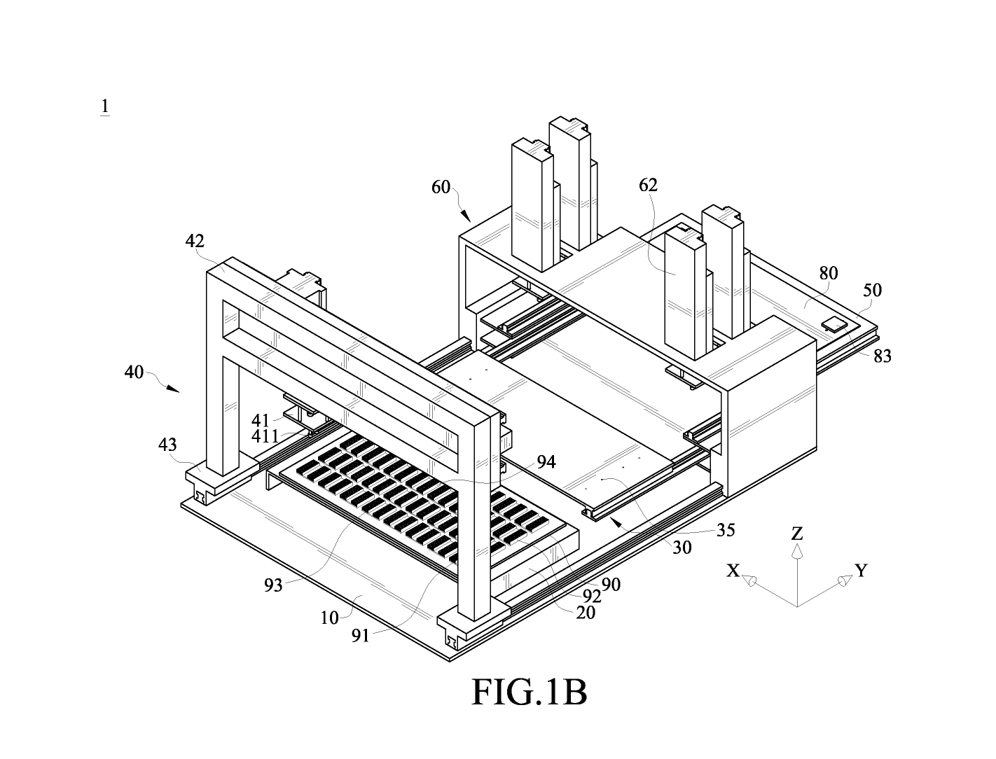

The assembly system is described as follows. Please refer to FIG. 1A through FIG. 2, FIG. 1A is a perspective view of an assembly system from a first viewpoint according to an embodiment of the disclosure. FIG. 1B is a perspective view of the assembly system from a second viewpoint according to the embodiment of the disclosure. FIG. 2 is a block diagram of a loading component and a carrier of the assembly system according to the embodiment of the disclosure. According to an embodiment of the disclosure, the assembly system 1 comprises a base seat 10, a carrier 20, a loading component 30, an electronic arm 40, a tray 50, and an assembly module 60. The carrier 20, the loading component 30, the electronic arm 40, the tray 50, and the assembly module 60 are disposed on the base seat 10. The assembly system 1 is for assembling the objects with a substrate 80. Additionally, in this embodiment, the objects are a plurality of heat dissipation fin sets 91, 92, 93 and 94 and the substrate 80 is a print circuit board.

The carrier 20 is for placements of the objects. In this embodiment, a plurality of placement regions are defined on the carrier 20. Moreover, the placement regions comprise a first region 21, a second region 22, a third region 23 and a fourth region 24 (as shown in FIG. 2). The heat dissipation fin sets 91 are disposed on the first region 21, the heat dissipation fin sets 92 are disposed on second region 22, the heat dissipation fin sets 93 are disposed on the third region 23, and the heat dissipation fin sets 93 are disposed on the fourth region 24. Furthermore, in this and some other embodiments, the heat dissipation fin sets 91, 92, 93 and 94 are disposed on a bearing plate 90 and arranged in a matrix. The bearing plate 90 is disposed on the carrier 20. Each of the heat dissipation fin sets 91, 92, 93 and 94 further comprises two push pins (not shown in FIGS.), and the two push pins 911 penetrates the heat dissipation fin sets 91, 92, 93 and 94 respectively, for fixing the heat dissipation fin sets 91, 92, 93 and 94 to a plurality of electronic components 81, 82, 83 and 84 on the substrate 80, respectively and sequentially.

However, the quantity of the push pin (not shown in FIGS.) of each of the heat dissipation fin sets 91, 92, 93 and 94 is not limited to two, and the quantity of the placement regions is not limited to four. In other embodiments, the quantity of the push pins of each of the heat dissipation fin sets 91, 92, 93 and 94 is one, three, or more than three. The quantity of the placement regions is a positive integer greater than one. The quantity of each heat dissipation fin set disposed on each placement region is a positive integer greater than one.

The loading component 30 is disposed next to the carrier 20, for positioning the heat dissipation fin sets 91, 92, 93 and 94. The predetermined positions are defined on the loading component 30. In this embodiment, the loading component 30 is a positioning jig and has a plurality of positioning holes 35. The push pins (not shown in FIGS.) are inserted into the plurality of positioning holes 35 for fixing the heat dissipation fin sets 91, 92, 93 and 94 to the loading component 30. The predetermined positions comprise a first position 31, a second position 32, a third position 33 and a fourth position 34. That is, the quantity of the predetermined positions is four. Additionally, the quantity of the placement region (as the first region 21, the second region 22, the third region 23 and the fourth region 24 in this embodiment) is substantially equal to the quantity of the predetermined positions (as the first position 31, the second position 32, the third position 33 and the fourth position 34 in this embodiment). In other words, the placement regions are corresponding to the predetermined positions one-by-one. When a user needs to assemble four heat dissipation fin sets 91, 92, 93 and 94 with one substrate 80, the user can define four predetermined positions (as the first position 31, the second position 32, the third position 33 and the fourth position 34 in this embodiment) in advance, the four predetermined positions are the positions where the user expects to assemble the heat dissipation fin sets 91, 92, 93 and 94. Then, the user can define placement regions (as the first region 21, the second region 22, the third region 23 and the fourth region 24 in this embodiment) on the carrier 20, relative positions of the first region 21, the second region 22, the third region 23 and the fourth region 24 are corresponding to relative positions of the first position 31, the second position 32, the third position 33 and the fourth position 34. Furthermore, in this embodiment, the electronic components 81, 82, 83 and 84 are located at four corners of the substrate 80 respectively, to form a square. Accordingly, the first position 31, the second position 32, the third position 33 and the fourth position 34 are arranged in a 2×2 matrix (2 by 2) and corresponding to the positions of the heat dissipation fin sets 91, 92, 93 and 94 on the substrate 80, respectively.

The electronic arm 40 is movably disposed on the carrier 20 and the loading component 30, for picking up the heat dissipation fin sets 91, 92, 93 and 94 from the carrier 20 and placing the heat dissipation fin sets 91, 92, 93 and 94 to the loading component 30.

In this and other embodiments, the electronic arm 40 further comprises a placement mechanism 41, a supporting frame 42 and a sliding rail 43. The sliding rail 43 is fixed to the base seat 10. The supporting frame 42 is movably assembled with the sliding rail 43, such that the supporting frame 42 can move along a direction parallel to X-axis. The placement mechanism 41 is movably assembled with the supporting frame 42, such that the placement mechanism 41 can move along the supporting frame 42 (along a direction parallel to Y-axis). The placement mechanism 41 is for picking up the heat dissipation fin sets 91, 92, 93 and 94 (along a direction parallel to Z-axis) from the first region 21, the second region 22, the third region 23 and the fourth region 24 of the carrier 20 and placing the heat dissipation fin sets 91, 92, 93 and 94 to the first position 31, the second position 32, the third position 33 and the fourth position 34 (along the direction parallel to Z-axis) of the loading component 30, respectively. Accordingly, the placement mechanism 41 can deliver the heat dissipation fin sets 91, 92, 93 and 94 along three directions (parallel to X-axis, Y-axis and Z-axis respectively). Moreover, the placement mechanism 41 of the electronic arm 40 further comprises a nozzle 411, for removing the push pins, such that placement mechanism 41 can deliver the heat dissipation fin sets 91, 92, 93 and 94 easily.

The tray 50 is for loading the substrate 80. The user can place the substrate 80 to be assembled (a raw substrate, without the heat dissipation fin sets 91, 92, 93 and 94) on the tray 50, or take out the substrate 80 assembled (a processed substrate, with the heat dissipation fin sets 91, 92, 93 and 94) from the tray 50.

The assembly module 60 is for picking up the heat dissipation fin sets 91, 92, 93 and 94 from the loading component 30, and affixing the heat dissipation fin sets 91, 92, 93 and 94 to the substrate 80 on the tray 50. Additionally, the loading component 30 and the tray 50 can be driven to move relative to the assembly module 60. When the loading component 30 is located under the assembly module 60, the assembly module 60 can pick up the heat dissipation fin sets 91, 92, 93 and 94 along the direction parallel to Z-axis from the first position 31, the second position 32, the third position 33 and the fourth position 34. When the tray 50 is located under the assembly module 60, the assembly module 60 can place the heat dissipation fin sets 91, 92, 93 and 94 at the electronic components 81, 82, 83 and 84 of the substrate 80 on the tray 50 along the direction parallel to Z-axis.

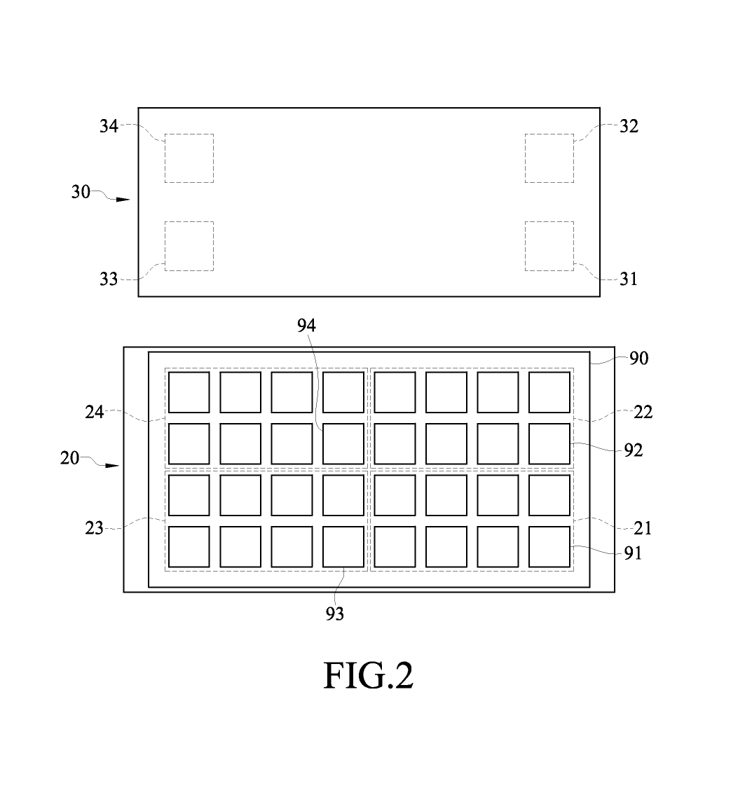

The delivery method is described and applied to the assembly system 1 as follows. However, the delivery method is, but not limited to, applied to the assembly system 1. Please refer to FIG. 2 and FIG. 3, FIG. 3 is a flow diagram of a delivery method according to the embodiment of the disclosure.

First, a plurality of placement regions are defined on the carrier 20 (as shown in step S100). A plurality of objects is placed at the placement regions, respectively. The quantity of the placement regions is equal to the quantity of the predetermined positions of the loading component 30. The placement regions are corresponding to the predetermined positions one-by-one.

Then, each object is picked up from each placement region, and placed at each predetermined position corresponding to each placement region (as shown in step S300).

In this embodiment, the placement regions comprise the first region 21, the second region 22, the third region 23 and the fourth region 24. The heat dissipation fin set 91 is placed at the first region 21, the heat dissipation fin set 92 is placed at the second region 22, the heat dissipation fin set 93 is placed at the third region 23, and the heat dissipation fin set 94 is placed at the fourth region 24. Both the quantities of the placement regions and the predetermined positions are four. The first region 21, the second region 22, the third region 23 and the fourth region 24 are corresponding to the predetermined positions one-by-one. In other words, the first region 21 is corresponding to the first position 31, the second region 22 is corresponding to the second position 32, the third region 23 is corresponding to the third position 33, and the fourth region 24 is corresponding to the fourth position 34. Moreover, in this embodiment, the relative positions of the first region 21, the second region 22, the third region 23 and the fourth region 24 are corresponding to the relative positions of the first position 31, the second position 32, the third position 33 and the fourth position 34. Furthermore, in this embodiment, the electronic components 81, 82, 83 and 84 are located at the four corners of the substrate 80 (as shown in FIG. 1A and FIG. 1B), respectively, such that the first position 31, the second position 32, the third position 33 and the fourth position 34 are arranged in a 2×2 matrix.

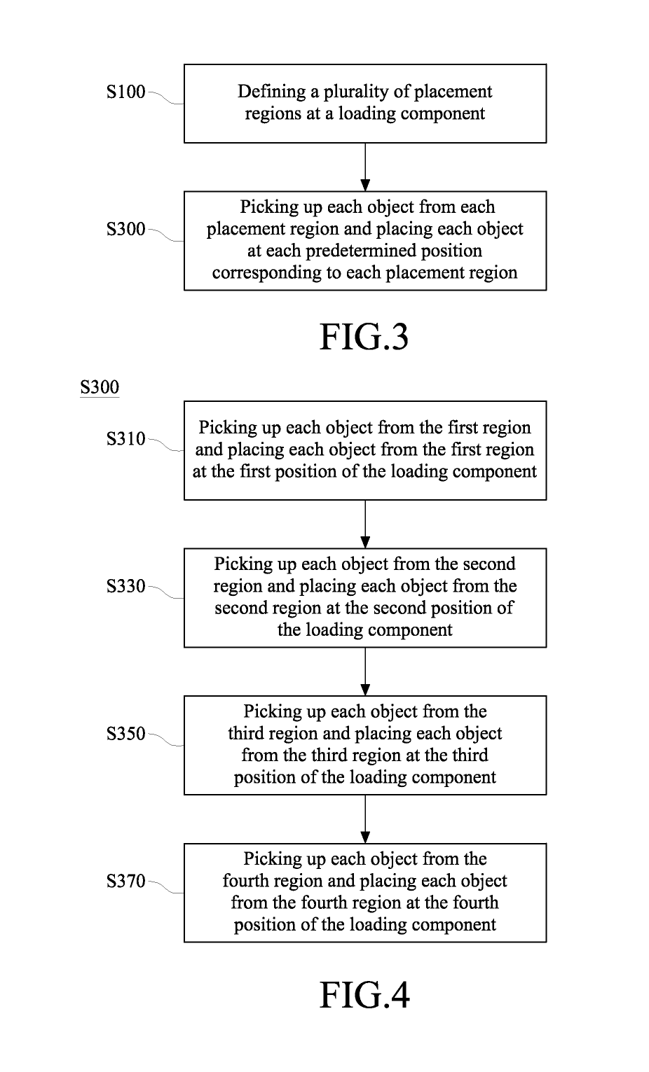

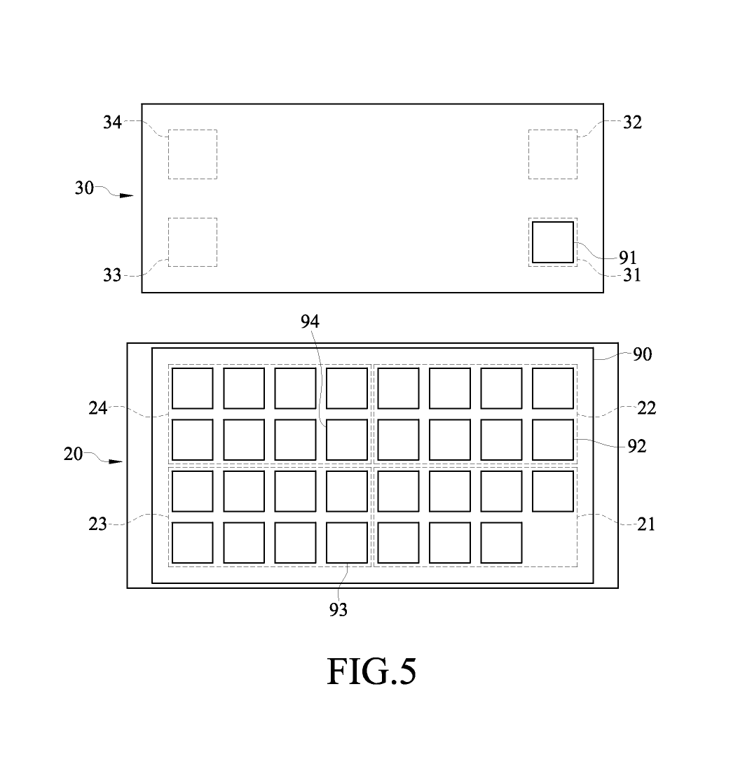

Step S300 is described as the following. Please refer to FIG. 1A, FIG. 1B, FIG. 4 and FIG. 5. FIG. 4 is a flow diagram of a step S300 in the delivery method according to the embodiment of the disclosure. FIG. 5 is a first schematic diagram of the delivery method applied to the assembly system according to the embodiment of the disclosure during operation.

The heat dissipation fin set 91 is picked up from the first region 21, and placed at the first position 31 of the loading component 30 (as shown in step S310) by the electronic arm 40. First, the electronic arm 40 moves to the place where is above the first region 21 along the directions parallel to X-axis and Y-axis, and picks up the heat dissipation fin set 91 along the direction parallel to Z-axis. Then, the electronic arm 40 moves to a place where it is above the first position 31 of the loading component 30 along the directions parallel to X-axis and Y-axis, and places the heat dissipation fin set 91 at the first position 31.

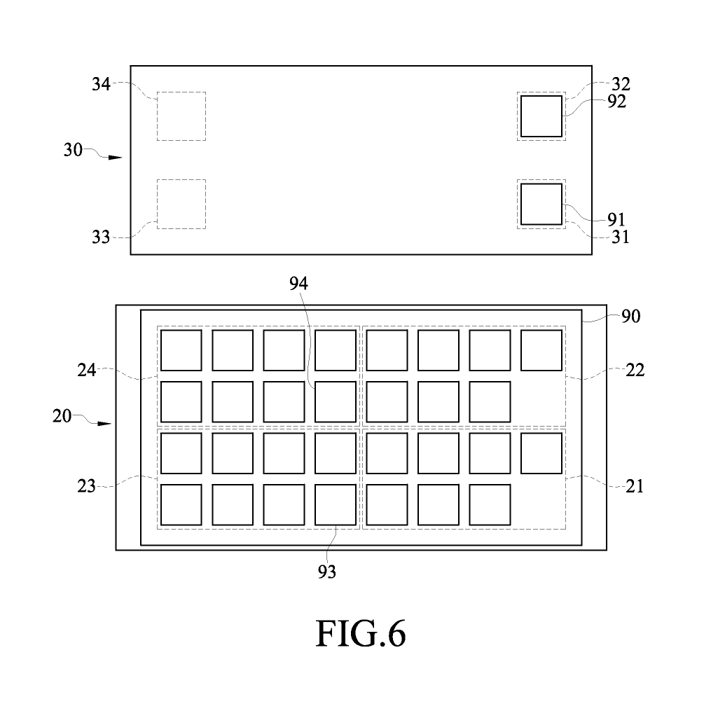

Please refer to FIG. 1A, FIG. 1B, FIG. 4 and FIG. 6. FIG. 6 is a second schematic diagram of the delivery method applied to the assembly system according to the embodiment of the disclosure during operation. The heat dissipation fin set 92 is picked up from the second region 22, and placed at the second position 32 of the loading component 30 (as shown in step S330) by the electronic arm 40. First, the electronic arm 40 moves to the second region 22 from the first position 31 of the loading component 30, and picks up the heat dissipation fin set 92. Then, the heat dissipation fin set 92 is placed at the second position 32 by the electronic arm 40 which moves along the directions parallel to X-axis, Y-axis and Z-axis respectively.

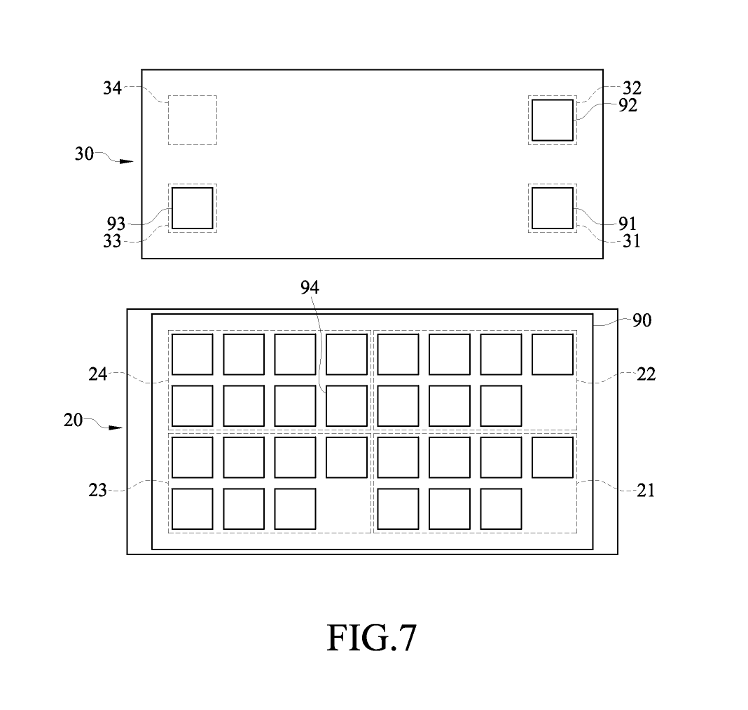

Please refer to FIG. 1A, FIG. 1B, FIG. 4 and FIG. 7. FIG. 7 is a third schematic diagram of the delivery method applied to the assembly system according to the embodiment of the disclosure during operation. The heat dissipation fin set 93 is picked up from the third region 23, and placed at the third position 33 of the loading component 30 (as shown in step S350) by the electronic arm 40. Similar to step 330, the electronic arm 40 moves to the third region 23 from the second position 32 and picks up the heat dissipation fin set 93 first. Then, the heat dissipation fin set 93 is placed at the third position 33 by the electronic arm 40.

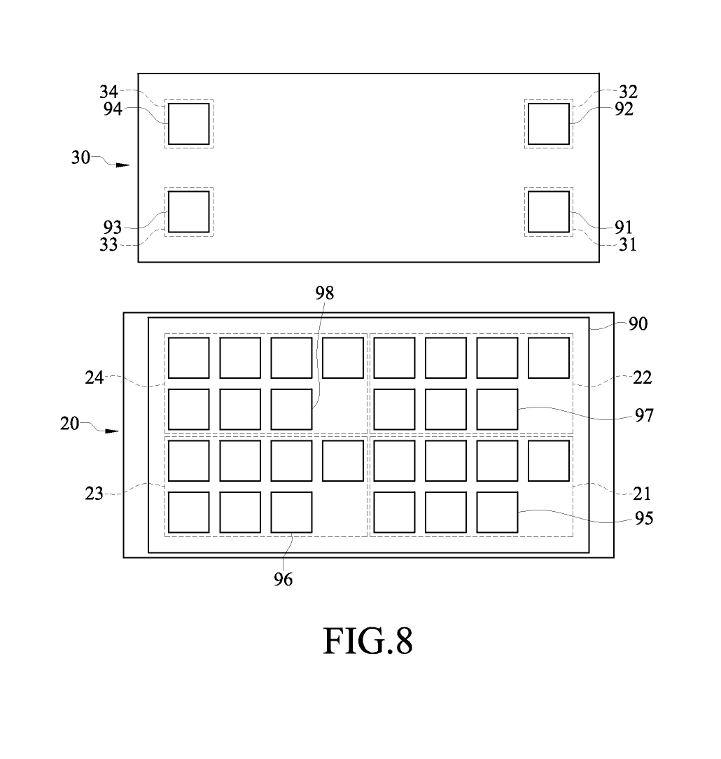

Please refer to FIG. 1A, FIG. 1B, FIG. 4 and FIG. 8. FIG. 8 is a fourth schematic diagram of the delivery method applied to the assembly system according to the embodiment of the disclosure during operation. The heat dissipation fin set 94 is picked up from the fourth region 24, and placed at the fourth position 34 of the loading component 30 (as shown in step S370) by the electronic arm 40. Similar to step 350, the electronic arm 40 moves to the fourth region 24 from the third position 33 and picks up the heat dissipation fin set 94 first. Then, the heat dissipation fin set 94 is placed at the fourth position 34 by the electronic arm 40. Based on steps S310 through S370, the heat dissipation fin sets 91, 92, 93 and 94 are delivered to the loading component 30. Then, the heat dissipation fin sets 91, 92, 93 and 94 can be assembled with the substrate 80 by the assembly module 60 in the follow-up process.

After all the heat dissipation fin sets 91, 92, 93 and 94 are picked up by the assembly module 60, another four heat dissipation fin sets 95, 96, 97 and 98 are sequentially delivered to the first position 31, the second position 32, the third position 33 and the fourth position 34 of the loading component 30 from the first region 21, the second region 22, the third region 23 and the fourth region 24 of the carrier 20, by the electronic arm 40, for being assembled with another substrate. Additionally, the heat dissipation fin sets 95, 96, 97 and 98 are drawn and picked up by the nozzle 411 of the nozzle 411, and placed at the loading component 30.

The movement of the electronic arm 40 of the disclosure is taken as an experimental group, and the movement of an electronic arm is taken as a control group. In the control group, the electronic arm of an assembly system only picks up the heat dissipation fin set sequentially without defining at least one placement region and at least one predetermined position. Additionally, the rotation speed of a motor for driving the electronic arm 40 to move along the direction parallel to X-axis is 800 rpm, the rotation speed of the motor for driving the electronic arm 40 to move along the direction parallel to Y-axis is 600 rpm in the experimental group (X-axis and Y-axis are shown in FIG. 1A), and the quantity of the objects is fifty. The rotation speed of a motor along the directions parallel to X-axis and Y-axis, and the quantity of the objects in the control group are the same as the experimental group. After an experiment, the delivery time in the experimental group is 43 minutes, and the delivery time in the control group is 51 minutes. Accordingly, the delivery time of the assembly system 1 can be shortened about 15.6%.

According to the delivery method of the disclosure, the delivery path of the electronic arm 40 from the first region 21, the second region 22, the third region 23 and the fourth region 24 of the carrier 20 to the first position 31, the second position 32, the third position 33 and the fourth position 34 of the loading component 30 (for delivering the heat dissipation fin sets 91, 92, 93, 94, 95, 96, 97 and 98) can be shorten, for improving the assembly time of the assembly system 1.

However, the delivery method of the disclosure is, but not limited to, applied to the assembly system 1. In other embodiments, the delivery method of the disclosure is applied to other kinds of delivery equipment.

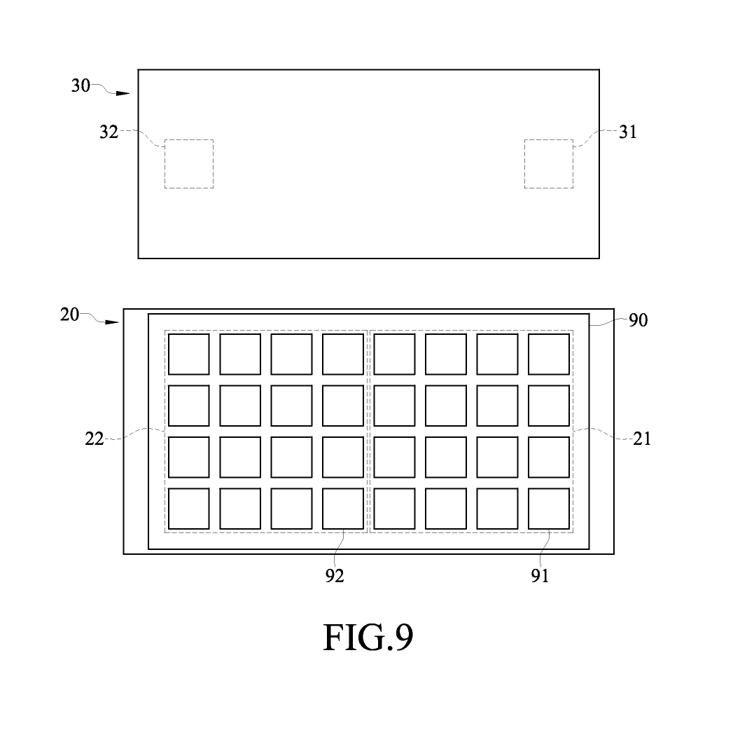

Moreover, both the quantities of the placement regions and the predetermined positions are not limited to four. Please refer to FIG. 9 which is a block diagram of a loading component and a carrier of an assembly system according to another embodiment of the disclosure. In this embodiment, two objects (heat dissipation fin sets 91 and 92) need to be assembled with the substrate (not shown in FIG.), such that two predetermined positions (the first position 31 and the second position 32) are defined on the loading component 30 and two placement regions (the first region 21 and the second region 22) are defined on the carrier 20. Additionally, the first position 31 and the second position 32 are neighboring in series, and the first region 21 and the second region 22 are also neighboring in series. Therefore, to complete the delivery process of the assembly system 1, the heat dissipation fin set 91 is picked up from the first region 21 and placed at the first position 31 of the loading component 30, and the heat dissipation fin set 92 is picked up from the second region 22 and placed at the second position 32 of the loading component 30, for improving the assembly time and efficiency of the assembly system 1.

To sum up, according to the delivery method of the disclosure, the placement regions are defined on the carrier, and the placement regions are corresponding to the predetermined positions. Thus, the delivery method of the disclosure can shorten the delivery path from the carrier to the loading component, for improving the assembly time and the assembly efficiency of the assembly system.

The disclosure will become more fully understood from the said embodiment for illustration only and thus does not limit the disclosure. Any modifications within the spirit and category of the disclosure fall in the scope of the disclosure.

What is claimed is:

1. A delivery method for placing a plurality of objects at a plurality of predetermined positions of a loading component, comprising steps of:
defining a plurality of placement regions, the plurality of objects being placed at the plurality of placement regions, respectively, the quantity of the plurality of placement regions being equal to the quantity of the plurality of predetermined positions of the loading component, and the plurality of placement regions being corresponding to the plurality of predetermined positions one-by-one; and
picking up each object from each placement region and placing each object at each predetermined position corresponding to each placement region.

2. The delivery method according to claim 1, wherein the plurality of placement regions comprise a first region and a second region, the plurality of predetermined positions comprise a first position and a second position, the first region is corresponding to the first position, the second region is corresponding to the second position, and the step of picking up each object from each placement region and placing each object at each predetermined position corresponding to each placement region further comprises:
picking up each object from the first region and placing each object from the first region at the first position of the loading component; and
picking up each object from the second region and placing each object from the second region at the second position of the loading component.

3. The delivery method according to claim 2, wherein a relative position of the first region and the second region is corresponding to a relative position of the first position and the second position.

4. The delivery method according to claim 2, wherein the plurality of placement regions further comprise a third region and a fourth region, the plurality of predetermined positions further comprise a third position and a fourth position, the third region is corresponding to the third position, the fourth region is corresponding to the fourth position, and the step of picking up each object from each placement region and placing each object at each predetermined position corresponding to each placement region further comprises:
picking up each object from the third region and placing each object from the third region at the third position of the loading component; and
picking up each object from the fourth region and placing each object from the fourth region at the fourth position of the loading component.

5. The delivery method according to claim 4, wherein a plurality of relative positions of the first region, the second region, the third region and the fourth region are corresponding to a plurality of relative positions of the first position, the second position, the third position and the fourth position.

6. The delivery method according to claim 1, wherein the first position, the second position, the third position and the fourth position are arranged in a 2×2 matrix.

7. The delivery method according to claim 1, wherein in the steps of picking up each object from each placement region and placing each object at each predetermined position corresponding to each placement region, each object is picked up from each placement region and placed at each predetermined position corresponding to each placement region by an electronic arm.

8. The delivery method according to claim 7, wherein each object is a heat dissipation fin set, and the loading component is a positioning jig.

9. The delivery method according to claim 8, wherein the heat dissipation fin set comprises a push pin, the electronic arm comprises a nozzle for sucking up each object from each placement region and placing each object at each predetermined position corresponding to each placement region.

10. A delivery method for placing a plurality of heat dissipation fin sets at a first position, a second position, a third position and a fourth position of a loading component, comprising steps of:
defining a first region, a second region, a third region and a fourth region on a carrier, the plurality of heat dissipation fin sets being placed at the first region, the second region, the third region and the fourth region, the first region being corresponding to the first position, the second region being corresponding to the second position, the third region being corresponding to the third position, the fourth region being corresponding to the fourth position, a plurality of relative positions of the first region, the second region, the third region and the fourth region being corresponding to a plurality of relative positions of the first position, the second position, the third position and the fourth position, and the first position, the second position, the third position and the fourth position being arranged in a 2×2 matrix;
picking up each heat dissipation fin set from the first region and placing each heat dissipation fin set from the first region at the first position of the loading component by the electronic arm;
picking up each heat dissipation fin set from the second region and placing each heat dissipation fin set from the second region at the second position of the loading component by the electronic arm;
picking up each heat dissipation fin set from the third region and placing each heat dissipation fin set from the third region at the third position of the loading component by the electronic arm; and
picking up each heat dissipation fin set from the fourth region and placing each heat dissipation fin set from the fourth region at the fourth position of the loading component by the electronic arm.
